(19) United States
(12) Patent Application Publication
(10) Pub. No.: US 2017/0160187 A1
(43) Pub. Date: Jun. 8, 2017

(54) Laser Scanner Particle Counter and Imager

(71) Applicant: TDK Corporation, Tokyo (JP)

(72) Inventors: Celine Hu, Tiburon, CA (US); Sumiko Kitagawa, Tokyo (JP); Koki Kawamura, Chiba (JP); Po-Kang Wang, Los Altos, CA (US)

(21) Appl. No.: 14/962,040

(22) Filed: Dec. 8, 2015

(51) Int. Cl. G01N 15/14

(52) U.S. Cl. CPC G01N 15/1434; G01N 2015/1486; G01N 2015/0065

(57) ABSTRACT

An apparatus for detecting the presence of a specific molecular species in a mixture of species operates by first flowing the mixture through microfluidic channels onto a substrate to which the specific species bonds, then attaching electromagnetic radiation scattering particles to the bonded species, then scanning the substrate with a uniform flux of laser radiation and relating the intensity of the scattered portion of the radiation to the density of particles captured by the molecular species affixed to the substrate. The substrate can be scanned either by: 1. applying oscillating mirrors to reflect the laser beam and uniformly scan the substrate; 2. moving the entire laser relative to the substrate so that its beam uniformly scans the substrate; 3. moving the entire substrate uniformly in the x-y plane while keeping the laser and its beam fixed.

### BACKGROUND

1. Technical Field

This disclosure relates generally to the use of lasers for detecting small particles, such as biological molecules, that may be captured on a surface.

2. Description

Currently, biological molecules can be detected and counted by several methods. One such method affixes small paramagnetic particles (“beads”) to the molecules, allows the bead-affixed molecules to bond to sites on an appropriate substrate, places the combined molecule/particle system in an appropriate external magnetic field and then detects the induced field of the paramagnetic particle. In effect, therefore, it is the magnetic particle that is being detected and, by implication, so is the biological molecule to which it is affixed. Using highly sensitive magnetoresistive magnetic tunneling junction (MTJ) sensors, paramagnetic beads on the order of 1 micron in diameter have been reliably detected.

Laser scanning and reading technologies have also been used to quantify and qualify particles bound on solid surfaces such as the surfaces employed when using MTJ sensors to detect the magnetic fields of magnetic beads affixed to the molecules. Laser scanners have also been used to detect particles moving in thin streams of air or fluid. Further, laser scanners have been used to detect particles in microfluidic channels radiating out from the center of a spinning disk. For example, CD, DVD and blu-ray scanners and readers have been employed to spin a disk at high speed while laser light impinges on the disk surface. The amount of reflected (or otherwise scattered) light is affected by the presence of the small light-scattering particles and is used to detect the number of small particles that are present. The prior arts have examples such as those mentioned briefly above. U.S. Pat. No. 8,227,260 to Yguerabide et al. teaches the use of lasers to detect particles. US Publ. Pat. Appl. 2014/0073043 to Holmes also mentions various methods of detecting small particles. US Publ. Pat. Appl. 2013/0210027 to Boisen et al., teaches a spinning detection device as discussed above.

It would be highly desirable to create a particle scanner and detector that would be smaller in size and less expensive than any of the magnetic sensing schemes described above. It would also be desirable to construct such a device that does not require that the particles to be detected be set spinning in order for their detection to occur. The prior arts do not offer a device that would accomplish these objects in an accurate, simple and inexpensive manner.

### SUMMARY

The first object of this disclosure is to provide a small, portable, inexpensive and ultra-high sensitivity device to quickly detect and quantify the presence of small particles.

The second object of this disclosure is to use the device described above to detect and quantify the presence of small particles that are paramagnetic or superparamagnetic particles or other material particles that can scatter electromagnetic radiation.

The third object of this disclosure is to provide such a device that can detect and quantify the presence of biological molecules, possibly contained in an analyte comprising multiple species of such molecules, to which small particles, which may be small paramagnetic or superparamagnetic particles, are affixed or otherwise associated and where it is these small magnetic particles that are being detected.

The fourth object of this disclosure is to provide such a device where the particles to be detected are entrained in a fluidic flow and introduced onto a substrate, through microfluidic channels, on which substrate analyte species are bonded, and captured while on that substrate surface whereupon the detection process then occurs.

The fifth object of this disclosure is to provide such a device that does not require that the particles to be detected be themselves placed in any particular type of motion.

The sixth object of this disclosure is to provide such a device where the particles to be detected are paramagnetic or superparamagnetic particles that are bonded to molecules which are themselves bonded to sites on the substrate.

The seventh object of this disclosure is to provide such a device where the substrate to which the particles are affixed may be mounted on a stage which can be placed in horizontal motion in an x-y plane.

The eighth object of this disclosure is to provide such a device that detects such particles by their effects in the scattering of electromagnetic radiation.

These objects, as well as others that can be envisioned from the detailed description to be given below, will be achieved by the use of a laser beam of electromagnetic radiation to create radiation scattering from small material particles bonded to molecular species. The laser radiation will be of appropriate wavelength and intensity for measureable scattering to occur and the laser will be operating in a two-dimensional scanning mode that is capable of irradiating a surface distribution of small magnetic particles or other small material particles or molecules to which such particles are affixed, in such a manner that the presence and amounts of such particles can be inferred from their scattering effects on the flux (intensity/area) of the incident radiation. These radiation-scattering particles, which may be small paramagnetic or superparamagnetic particles, but which can also be non-magnetic material particles capable of scattering electromagnetic radiation, will generally be introduced into or onto a substrate through microfluidic channels guiding thin streams of air (gas) or other fluids that entrain the particles. The substrate will already have an analyte species of interest bonded to it and the radiation-scattering particles, having thus been microfluidically introduced to the substrate, can themselves bond to sites the species. Then the irradiation of the substrate will proceed and associated optical-electronic circuitry will be capable of measuring the flux of laser radiation scattered from the captured particles (e.g., incident flux-transmitted flux). The captured particles will affect the incident radiation by scattering it out of the incident direction either through reflection, scattering, re-radiation or absorption (depending on the nature of the particles and the radiation), so that the flux of the transmitted radiation will be changed by an amount and in a manner that is directly related to the number of scattering or absorbing particles in the path of the radiation.

To accomplish the actual process of scanning the captured particles by laser radiation, instead of placing the particles in motion relative to a fixed laser beam, the laser beam will be set in motion (in the x-y plane of the substrate) relative to fixed particles. The moving laser beam will be reflected (scattered) from the particles and the variation of reflected intensity or the total reflected flux will be used to detect and quantify those particles. The scanning operation can be produced by moving the laser itself, by using an oscillating mirror or equivalent optical refracting mechanism to scan the beam of a fixed laser across a flat surface or, alternatively, to move the surface to which the particles are affixed by mounting the substrate on a moving stage. These different modes of radiation movement across the distribution of particles may be carried out singly or in combination. Preferably, in whatever mode the scanning occurs, the particles being scanned will be fixed to a substantially horizontal, planar substrate of small, well defined area, so that the scanning process is itself efficiently carried out with a minimum of non-linearities that would be introduced if the scanning took place over a large region. Further, by maintaining a small area to be scanned, the scanning speed may be kept small, which is an additional advantage. Finally we note that the size of the scattering particles to be used in this process are in the range of between 0.5 and 3.0 microns (μm). We also note that magnetic particles in this size range will be superparamagnetic, but that other appropriate light-scattering particles, not necessarily magnetic in nature, can be used. The use of magnetic particles offers the ability to utilize possible interactions with magnetic fields to obtain additional advantages in the process, such as a method to enhance the microfluidic transport.

### BRIEF DESCRIPTION OF THE DRAWINGS

FIG. 1 is a schematic representation of an exemplary apparatus capable of achieving the objects of this disclosure.

FIG. 2 is a more detailed illustration showing a more detailed image of the chip stage of the apparatus of FIG. 1 on which the actual counting of labeled particles will occur.

### DETAILED DESCRIPTION

The present disclosure describes three modes of operation of an apparatus for counting small light-scattering particles, particularly when such small light-scattering particles are affixed or otherwise bonded to a molecular species that has been captured on a substrate. The substrate may be a silicon chip or a suitable glass element whose surface is covered with bonding sites that are capable of capturing the molecular species whose numbers are to be counted. It is the molecular species whose presence or absence on the substrate is the primary purpose of the counting process.

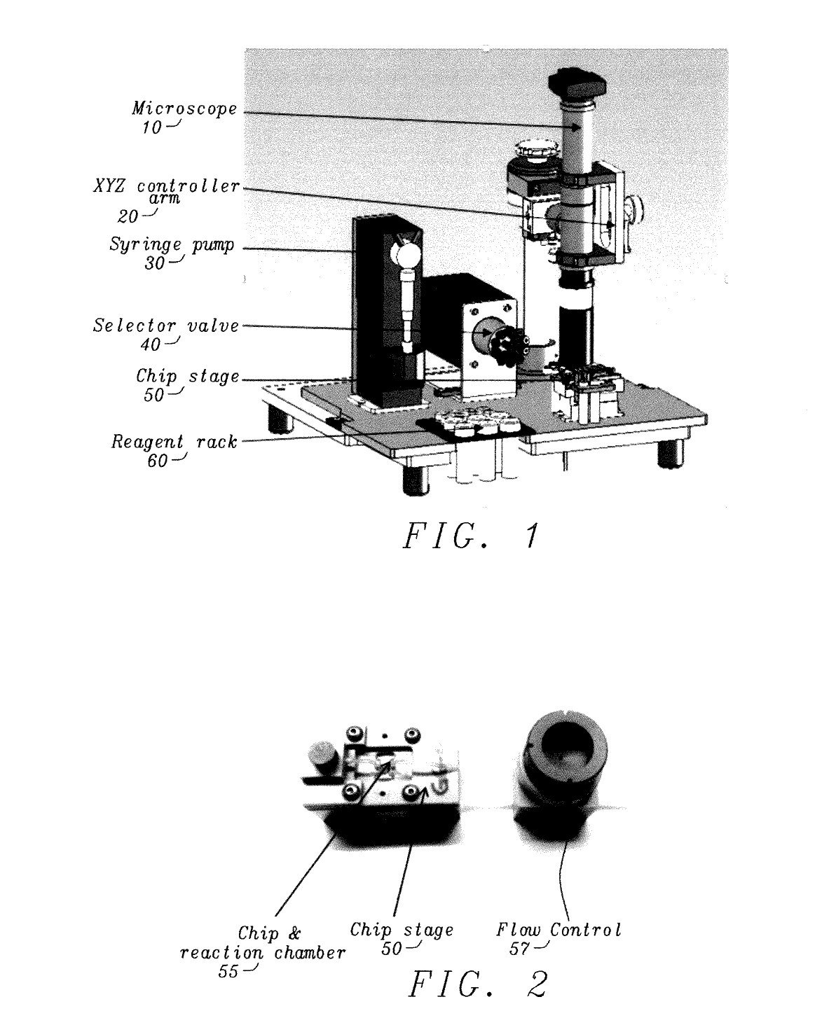

Typically, the particular molecular species of interest is a biological molecule and it is part of an analyte (e.g., a blood sample or biochemical mixture) that may contain a multiplicity of other species whose presence is not of immediate interest. The substrate of the counting apparatus, which may be a silicon chip or glass layer is preferably made the bottom plate of an enclosed module, forming a reaction chamber that is part of a larger apparatus as will be described in FIG. 1. The substrate is covered with a distribution of bonding sites that are specific for adhering to a molecule of interest, but the number of such molecules that have been captured is unknown, so their presence on the substrate is to be determined by affixing light-scattering particles to them and then counting the light scattering particles. The light scattering particles are introduced into the reaction chamber by entraining them in a gas or fluid and injecting them through microfluidic channels. They are then affixed to the molecules after the molecules themselves have been captured and bonded by the substrate. Since the light-scattering particles may be relatively massive compared to the molecules, having the molecules already bonded to the substrate can be advantageous to forming effective bonds between the molecules and the particles. The process of bonding the light-scattering particles to the captured molecular species is carried out within the apparatus reaction chamber module that contains the substrate and the already bonded molecular species. The reaction chamber contains an array of micro-fluidic channels that may be used both for injecting the analyte as well as subsequently injecting a solution containing the light-scattering particles. Alternatively, different paths may be used to introduce the analyte and the fluid or gas entrained light-scattering particles.

Specifically, this disclosure provides a general method for determining the presence of a fixed distribution of molecules bound to a substrate by detecting small light-scattering particles bound to the molecules. In short, it is the presence or absence of the small light-scattering particles that is directly ascertained, and the presence of the biological molecules is inferred. The small particles are themselves detected as a result of their scattering effects on a beam of laser radiation that is incident on them. The incident intensity of the beam is known as well as the area being scanned and the scattered portion or the transmitted portion may be measured, depending on the circumstances. It is the scattered portion that will be proportional to the surface density of scatterers producing that portion.

The mechanism controlling the beam of radiation may move the laser itself, or it may oscillate only the beam, or it may move the substrate being scanned while leaving the laser fixed. Preferably, the light-scattering particles are superparamagnetic beads, in the range of between 0.5 and 3.0 microns (μm), but preferably about 1 μm in diameter.

The operation of the apparatus as a detector of biological molecules (or other molecular species) requires that the light-scattering particles flow in microfluidic channels and be bound to a substrate on which the biological molecules are captured. When the particles affix themselves at a defined portion of the substrate they can be scanned by laser radiation. The light-scattering superparamagnetic (or other) affixed particles, scatter light from the impinging beam of laser radiation which is scanning over the area of the substrate on which the molecules are bonded. The intensity of the scattered radiation as a fraction of the intensity of the impinging radiation is a measure of the density of scatterers affixed to the substrate and, by inference, the density of the molecular species whose presence is sought. Most simply, the scattered intensity is calculated by subtracting the transmitted intensity from the incident intensity.

As noted above, the laser radiation can be made to impinge uniformly on the region of the substrate on which the molecules are bonded in at least three ways and their combinations.

1. The laser is fixed and the laser beam is scanned uniformly over the substrate area using (for example) oscillating mirrors to deflect the beam.

2. The laser itself is moved so that its beam remains fixed relative to the laser, but its beam scans the surface of the substrate uniformly.

3. The laser and its beam are fixed, but the substrate is moved laterally in the X and Y directions so that the defined area is uniformly impinged upon.

An object of the process is to complete the scan in as short a time period as possible and since the area of the substrate being scanned is on the order of centimeters, achieving this should not require an excessive scanning rate.

Referring first to schematic FIG. 1, there is shown an example of a complete apparatus that can be operated to fulfill the objects of this disclosure. It is understood that this apparatus will be ultimately reduced in size by minimizing the dimensions of certain of its components and arranging them in an optimal package. The apparatus shown here is for the purpose of illustrating the separate elements and their modes of operation.

The apparatus as presently shown comprises a microscope/laser optical counting portion (10). This part of the apparatus may contain the laser used for the actual scanning of the light-scattering particles and for determining the scattered flux required to count the light-scattering particles that are bound to the molecular species which, in turn, are bound to the substrate that forms the base of the chip stage (50). Various ancillary optical elements are envisioned depending upon the method used to scan the chip stage and the method used to determine the scattered flux. If the substrate is transparent (e.g., glass), the transmitted flux can be directly measured and subtracted from the incident flux, which is known. If the substrate is not transparent, then it may be necessary to measure the scattered flux using an array of surrounding photosensors. In either case, the quantity required to compute the density of scatterers is the scattered flux.

An XYZ controller arm (20) can be used to position the optical element and a mechanized controller can be used to scan the laser as a whole relative to the chip stage. A syringe pump, (30) controls the flow of analyte as well as the entrained scatterers into the reaction chamber that holds the chip stage. Ancillary apparatus includes a selector valve (40) that controls the choice of analyte, scatterers, bonding reagents, etc., that are contained in the reagent rack (60).

Referring next to FIG. 2, there is shown a more detailed view of the chip and reaction chamber (55) that forms a part of the chip stage (50). The chip may be a silicon chip if some form of integrated signal processing of the scattered radiation is to be performed. Alternatively, the chip may be replaced by a glass substrate that holds the bound molecular species and allows the transmitted laser radiation to pass through and be measured. The chip and reaction chamber contains the chip substrate covered by a transparent cover through which the laser beam enters to scan the chip. Depending on the type of scanning being applied, the chip and reaction chamber may oscillate within the chip stage relative to a fixed beam that enters the chamber. Alternatively, the chip stage will remain stationary and the laser beam will scan the chip either by an oscillation of the beam or by a movement of the laser itself.

As is understood by a person skilled in the art, the present description is illustrative of the present disclosure rather than limiting of the present disclosure. Revisions and modifications may be made to methods, materials, structures and dimensions employed in forming, providing and using an apparatus for detecting the presence of small light-scattering particles affixed to biological molecules while still forming, providing and using such a structure in accord with the spirit and scope of the present disclosure as defined by the appended claims.

What is claimed is:

1. A particle detector comprising:
A reaction chamber including a planar, horizontal substrate containing microfluidic channels and a region capable of being supplied by contents flowing through said microfluidic channels, wherein said contents comprise gas or fluid entrained particulates, capable of scattering electromagnetic radiation;
a distribution of bonding sites formed on said region whereat said particulates entrained in said fluids flowing in said channels are capable of being bonded;
a laser, capable of generating a beam of electromagnetic radiation having a frequency and an intensity, wherein said beam is capable of being scanned across said region to produce a flux of incident electromagnetic radiation uniformly distributed over said region;
wherein said radiation is capable of being scattered by said particulates; and
associated circuitry whereby the intensity of the scattered portion of said scanned radiation is measured and related to the density of radiation scattering particulates bonded to said region.

2. The particle detector of claim 1 wherein said bonding sites are sites on a molecular species which is itself bonded to said substrate and to which said particulates have subsequently become affixed.

3. The particle detector of claim 2 wherein said particulates are superparamagnetic particles of a diameter between approximately 0.5 and 3.0 microns.

4. The particle detector of claim 1 wherein said beam of electromagnetic radiation is scanned across said region by reflecting said beam of electromagnetic radiation using an oscillating mirror while said laser is fixed in position.

5. The particle detector of claim 1 wherein said beam of radiation is scanned across said region by maintaining the beam of radiation fixed relative to said laser and moving said laser relative to said region so that the beam scans the region producing a uniform flux distribution.

6. The particle detector of claim 1 wherein said laser and said beam of radiation is fixed in space but wherein said region is moved horizontally in the x-y plane in such a way as to cause the incident radiative flux to be deposited uniformly on the region.

7. The particle detector of claim 1 wherein said region is substantially a square region approximately 2.0 cm on a side.

8. The particle detector of claim 1 wherein said laser is a solid state laser having a wavelength that is less than the dimensions of said particles.

9. The particle detector of claim 1 where the bonding sites are formed as sites specific to a particular molecular species.

10. A method for determining the presence and quantity of a molecular species bonded to a substrate, comprising:
providing a sample of said molecular species bonded to a distribution of first sites randomly distributed over a region of known area on the surface of a substrate;
affixing a small light-scattering particle to each of said molecular species by microfluidically injecting said light-scattering particles entrained in a gas or fluid and causing said light-scattering particles to bond to a second site located on said molecular species;
using a laser producing a beam of incident electromagnetic radiation of determined intensity and frequency, scanning said region of known area for a known amount of time while producing an incident radiation flux of uniform area distribution;
measuring the amount of radiation scattered from said incident beam and relating the amount of scattered radiation to the density of light-scattering particles bonded to said affixed molecular species;
equating the density of scatterers to the density of said molecular species.

11. The method of claim 10 wherein said particulates are superparamagnetic particles of a diameter between approximately 0.5 and 3.0 microns.

12. The method of claim 10 wherein said beam of electromagnetic radiation is scanned across said region by reflecting said beam of electromagnetic radiation using an oscillating mirror while said laser is fixed in position.

13. The method of claim 10 wherein said beam of electromagnetic radiation is scanned across said region by refracting said beam of electromagnetic radiation using an oscillating refractive element while said laser is fixed in position.

14. The method of claim 10 wherein said beam of radiation is scanned across said region by maintaining the beam of radiation fixed relative to said laser and moving said laser relative to said region so that the beam scans the region producing a undo′ flux distribution.

15. The method of claim 10 wherein said laser and said beam of radiation is fixed in space but wherein said region is moved horizontally in the x-y plane in such a way as to cause the incident radiative flux to be deposited uniformly on the region.

16. The method of claim 10 wherein said region is substantially a square region approximately 2.0 cm on a side.

17. A method for determining the presence and quantity of a particular molecular species within an analyte containing a mixture of different molecular species, comprising:
providing an analyte containing mixture of different molecular species;
flowing a given amount of said mixture into a reaction chamber comprising an enclosed substrate having a region of known area endowed with a distribution of sites specifically capable of bonding to the particular one of said molecular species to be identified and quantified; then, after said bonding is assumed to have occurred;
affixing a small electromagnetic radiation-scattering particle to each of said molecular species assumed bound to said substrate by microfluidically flowing a gas or fluid entrained mixture of said radiation-scattering particles, into said reaction chamber and initiating a process of affixation to said molecular species; then
using a laser producing an electromagnetic radiation beam of appropriate intensity and frequency, scanning said region for a known amount of time to produce an incident radiation flux of uniform area distribution; then
measuring the amount of radiation scattered from said incident flux and relating said amount of scattered flux to the density of radiation-scatterers affixed to said particular molecular species;
equating the density of scatterers to the density of said particular molecular species.

18. The method of claim 17 wherein said particulates are superparamagnetic particles of a diameter between approximately 0.5 and 3.0 microns.

19. The method of claim 17 wherein said beam of electromagnetic radiation is scanned across said region by reflecting said beam of electromagnetic radiation using an oscillating mirror while said laser is fixed in position.

20. The method of claim 17 wherein said beam of electromagnetic radiation is scanned across said region by reflecting said beam of electromagnetic radiation using an oscillating refraction element while said laser is fixed in position.

21. The method of claim 17 wherein said beam of radiation is scanned across said region by maintaining the beam of radiation fixed relative to said laser and moving said laser relative to said region so that the beam scans the region producing a uniform flux distribution.

22. The method of claim 17 wherein said laser and said beam of radiation is fixed in space but wherein said region is moved horizontally in the x-y plane in such a way as to cause the incident radiative flux to be deposited uniformly on the region.
